(19) United States
(12) Patent Application Publication
(10) Pub. No.: US 2012/0139150 A1
(43) Pub. Date: Jun. 7, 2012

(54) Method And Device For Producing A Grass Yarn

(75) Inventors: Siegfried Behnert, Gornau (DE); Jens Weinhold, Chemnitz (DE); Frank Heymann, Chemnitz (DE)

(73) Assignee: OERLIKON TEXTILE GMBH & CO. KG, Remscheid (DE)

(21) Appl. No.: 13/390,585

(22) PCT Filed: Aug. 5, 2010
(86) PCT No.: PCT/EP10/61414

§ 371 Date: Feb. 15, 2012

(30) Foreign Application Priority Data
Aug. 17, 2009 (DE) 10 2009 037 740.9

(51) Int. Cl. B29C 53/32; B29C 47/00

(52) U.S. Cl. 264/146; 425/380

(57) ABSTRACT

The invention relates to a method and a device for producing a grass yarn for artificial turf. A film is produced from a polymer material in an extrusion process and divided into individual strips. The strips are crimped before being coiled into spools. The aim of the invention is to achieve a structure which particularly matches natural grass. According to the invention, this is achieved in that the film or the strips are fibrillated by a needle roller before crimping and the strips are separated after on and individually crimped independently of each other.

The invention relates to a method for producing a grass yarn for artificial turf and a device for carrying out the method.

So-called grass yarns, which are preferably produced as a combination of a plurality of monofilaments or a plurality of synthetic strips, are used in the production of artificial turf. The grass yarn is then processed to form an artificial turf carpet using a tufting process. Within the artificial turf, the artificial blades of grass are formed by the monofilaments or by the strips. Here, the aim is for the artificial fibers to replicate characteristics of natural grass as far as possible. It is therefore known to match the cross sections, coloring and structure of the monofilaments or strips to natural grass. In order to improve the characteristics of artificial turf, in particular the elasticity and the ability of the individual fibers to straighten up, it has become apparent that this can be made possible particularly by grass yarns which have a strongly crimped structure.

A grass yarn which is formed from a plurality of textured synthetic strips is disclosed in EP 1 728 902 A1. For this purpose, the strips are produced in an extrusion process, for example from a film, and textured in groups of several strips using compression chamber crimping. With this method, a substantially three-dimensional crimping of the strips occurs. However, strips of this kind produced with constant width do not have the irregularity and fibrousness which are typical of natural grass. In this respect, crimped strips of this kind are only suitable for the production of artificial turf in conjunction with further strips and monofilaments.

In contrast with this, the invention is based on the object of creating a method for producing a grass yarn for artificial turf of the kind described and a device for carrying out the method, with which a synthetic strip, whose characteristics very closely approximate to natural grass, can be produced.

This object is achieved by a method with the characteristics as claimed in claim 1 and by a device with the characteristics as claimed in claim 7.

Advantageous improvements of the invention are defined by the characteristics and combinations of characteristics of the respective dependent claims.

In the search for a solution, the person skilled in the art would of course come across the publications DE 21 60 779 A1 and DE 21 56 114 A1. Methods for producing crimped fibers in which the strips are fibrillated before crimping are disclosed in the stated publications. For this purpose, the strips are crimped as a skein after fibrillation so that a uniform crimping structure is produced in the individual strips. In addition, with the method disclosed in DE 1 903 650, the skein of strips is fed over an edge, thus producing a mechanically conditioned two-dimensional crimping.

In contrast with this, the invention avoids a group treatment of the strips and produces an individual fibrous crimped structure in every single strip. For this purpose, the film or strips is/are fibrillated by a needle roller before crimping. After fibrillation, the strips are separated and crimped individually independently of each other.

For this purpose, the device according to the invention has a fibrillation device with at least one needle roller which is disposed before the crimping device. The crimping device is formed from a plurality of texturing means for crimping individual strips.

The method according to the invention and the device according to the invention have the particular advantage that a textured strip is produced, which is externally identical to a textured bundle of fibers made from a plurality of monofilaments. Texturing the fibrillated strips opens the fibrillations so that the strip appears to be formed from a plurality of individual filaments. The fibrillation is not destroyed during texturing however, and the mesh structure of the fibrillated strip is retained and thus produces a cohesion of the individual filaments of the strip. The degree of cohesion and the degree to which the appearance is apparently identical to that of a textured bundle of monofilament fibers can be influenced by the structure and the degree of fibrillation of the strip.

In this respect, the variations of the method according to claims 2 and 3 are particularly preferred in order to influence the structure of the strips. According to a first variation of the method, the needle roller for producing the fibrillation pattern is driven at a peripheral speed which is substantially equal to or not equal to a production speed of the film or strips.

In addition, the fibrillation pattern can be produced in the film or strips by a parallel arrangement of needles or an offset arrangement of needles on the needle rollers. This results in web-like or mesh-like fibrillations.

The variation of the method in which the fibrillated strips are crimped individually within a compression chamber, wherein the strip is fed through a conveyor nozzle to the compression chamber, is used to produce three-dimensional crimping. At the same time, this enables thermal effects to be used during the crimping of the strip in that the conveyor nozzle is operated with a heated conveyor medium.

Fibrillated and crimped strips of this kind are basically suitable as grass yarn for producing artificial turf. However, a plurality of crimped strips can also advantageously be brought together with others to form a composite yarn before being coiled.

The visual characteristics of the grass yarn are preferably set up by the variation of the method in which the film is produced by coextrusion of two polymer materials based on a polymer of different colors. For example, this enables the two sides of the strips to be formed in different shades of green.

The method according to the invention and the device according to the invention are explained in more detail below with reference to an exemplary embodiment of the device according to the invention.

In the drawing:

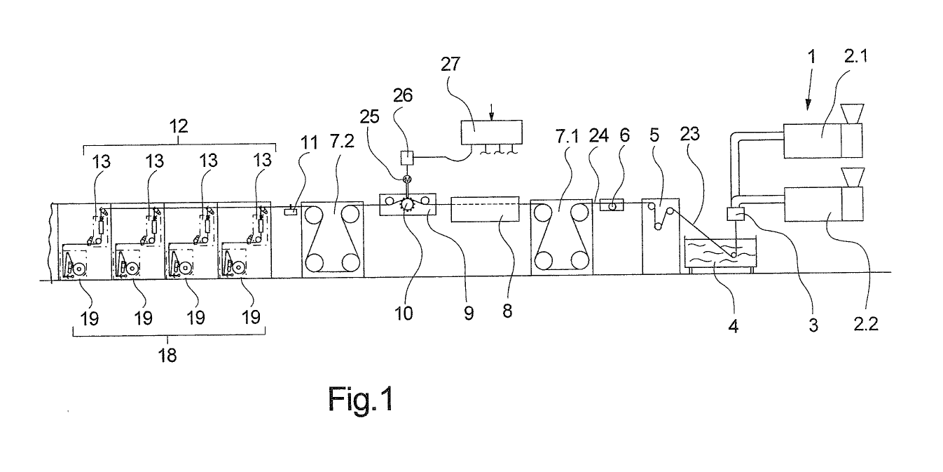

FIG. 1 shows schematically a view of a first exemplary embodiment of the device according to the invention for carrying out the method according to the invention.

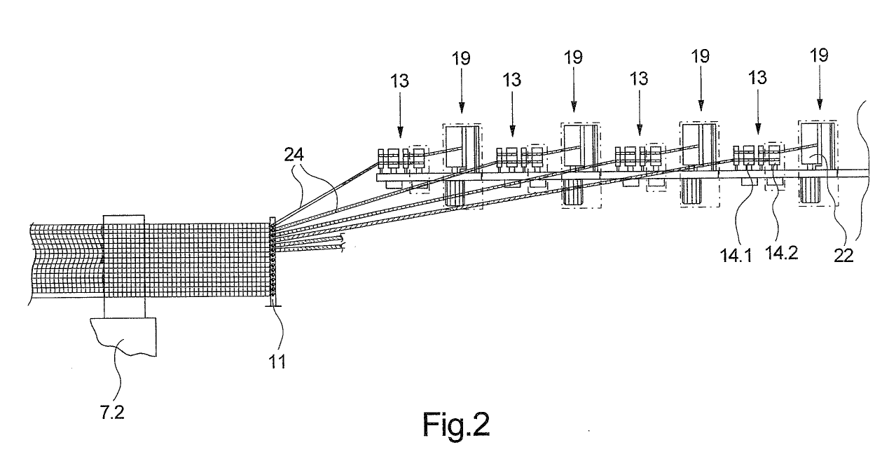

FIG. 2 shows schematically a part view of a plan view of the exemplary embodiment of FIG. 1

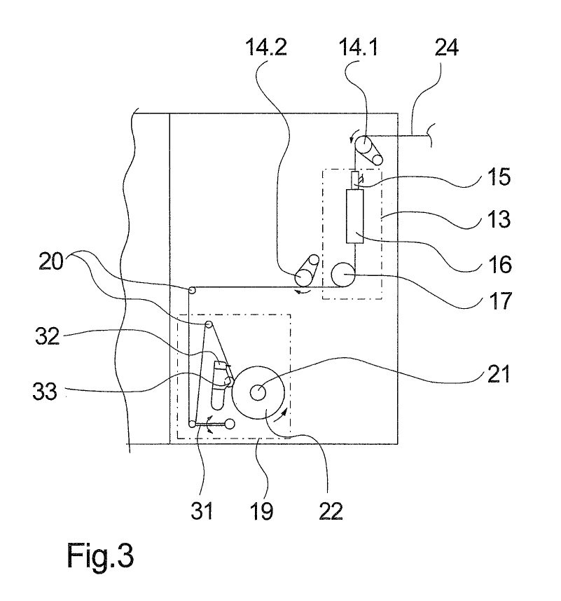

FIG. 3 shows schematically a part view of a side of the exemplary embodiment of FIG. 1

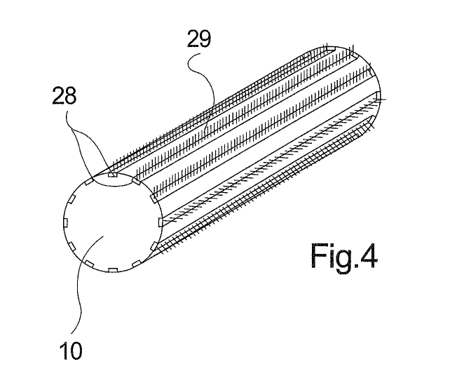

FIG. 4 shows schematically a view of a needle roller

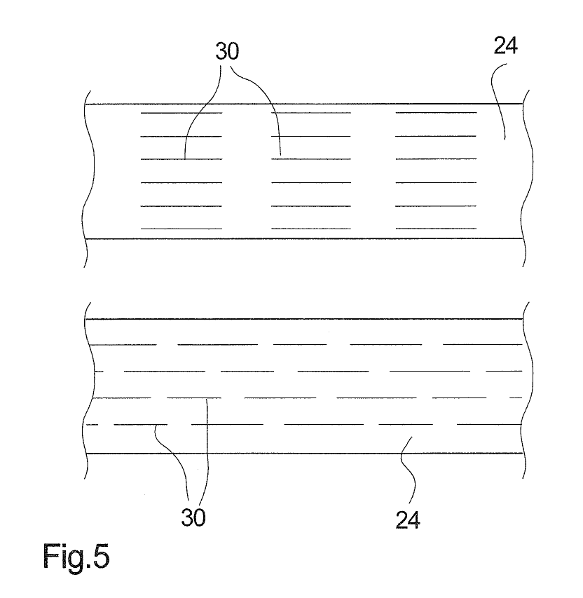

FIG. 5 shows schematically several plan views of individually fibrillated strips.

An exemplary embodiment of the device according to the invention for carrying out the method according to the invention for producing a grass yarn is shown schematically in FIGS. 1 to 3. The exemplary embodiment is shown in an overall view in FIG. 1, in a part view of a plan view in FIG. 2, and in a part view of the side in the region of the coiling device in FIG. 3. The following description applies to all figures when no express reference is made to one of the figures.

The exemplary embodiment of the device according to the invention is shown in an overall view in FIG. 1. The exemplary embodiment has an extrusion device 1 in order to produce a film from a thermoplastic material. In this example, the extrusion device 1 has two extruders 2.1 and 2.2. The extruders 2.1 and 2.2 could extrude polymer materials based on a polymer in different colors, for example, in order to produce a two-colored flat film, for example. However, it is also basically possible to extrude different polymer materials of different polymers with each of the extruders 2.1 and 2.2.

The extruders 2.1 and 2.2 are connected to an extrusion head 3 which extrudes the polymer materials to form a flat film by coextrusion.

A cooling bath 4 is associated with the extrusion head 3. A deflector unit 5 with a plurality of deflector rolls, on the periphery of which the film is guided with a single wrap, is provided on the outlet side of the cooling bath 4. The deflector unit 5 is usually combined with a suction system in order to remove the cooling liquid from the cooling bath which clings to the film.

In order to cut the film 23 produced in the extrusion device 1 into a skein of strips 24, a cutting device 6 is arranged after the deflector unit 5. In the cutting device 6, the film is cut into a plurality of individual strips with predetermined width.

A plurality of godet feed units 7.1 and 7.2 with driven godets are arranged successively in order to pull off the film and stretch the strips. In doing so, the strips 24 are guided in parallel runs next to each other with a single wrap on the circumference of the driven godets of the godet feed units 7.1 and 7.2.

A heating device 8 is arranged between the godet feed units 7.1 and 7.2. The heating device 8 could be formed by a circulating air oven, for example, in which the strips are heated to a stretch temperature. The godets of the godet feed units 7.1 and 7.2 are driven with a speed difference in order to stretch the strips.

A fibrillation device 9 is arranged between the heating device 8 and the second godet feed unit 7.2. The fibrillation device 9 has a needle roller 10, on the circumference of which the strips are guided with a partial wrap for the purpose of fibrillation. The needle roller 10 is driven by an electric motor 25 which is controlled by the control unit 26. The control unit 26 is coupled to a machine controller 27, enabling a peripheral speed of the needle roller 10 to be set as a function of the production speed of the strips defined by the godet drives. In this way, the needle roller 10 can be driven at a peripheral speed which is equal to or greater than the production speed of the strips for the purpose of fibrillation.

After stretching, the strips 24 are separated by a guide bar 11 which is arranged on the outlet side of the second godet feed unit 7.2. A crimping device 12 and a coiler 18 are provided for further handling of the strips. The crimping device 12 has a plurality of texturing means 13, by means of which one strip is crimped in each case.

To further explain the separate handling of the strips, additional reference is made to FIGS. 2 and 3. A plan view of the crimping device 12 and the coiler 18 is shown in FIG. 2. One of the texturing means 13 and one coiler station 19 of the coiler 18 are shown in FIG. 3. The following description applies to all figures when no express reference is made to one of the figures.

After the strips 24 have been separated, they are distributed between the individual texturing means 13 and coiler stations 19. Crimping of the fibrillated strip 24, which is subsequently coiled to form a spool in the coiler station 19, takes place in each of the texturing means 13. The units and the route of the thread to the texturing and coiling process can be seen particularly from the diagram in FIG. 3. The strip 24 is fed to the crimping process by the godet units 14.1 and 14.2. The texturing means 13, which in this exemplary embodiment is formed by a conveyor nozzle 15, a compression chamber 16 connected to the conveyor nozzle 15, and a discharge roller 17 disposed after the compression chamber 16, is arranged between the godet units. The conveyor nozzle 15 is connected to a fluid source in order to convey the strip 24 into a compression chamber 24. A heated compressed air is preferably used as the conveyor medium in order to simultaneously heat the synthetic strip 24. Crimping of the strip is carried out within the compression chamber 16, which causes the fibrillations in the strip to open. The crimped strip is subsequently pulled off the discharge roller 17 by the godet unit 14.2 and fed to the coiler station 19. In the coiler station 19, the strip 24 is coiled into a spool 22 which is retained on a driven spool holder 21. The coiler station 19 has a dancer arm controller 31, and iridescing device 32 and a snubber roll 33 for guiding the thread. The entry of the strip and the guiding of the strip to the dancer arm controller are carried out by deflector rolls 20.

A grass yarn, which could be directly processed in a subsequent process to form artificial turf, is produced in the exemplary embodiment shown in FIG. 1 to 3. Basically, however, it is also possible, after the strips have been textured, for a plurality of strips to be brought together to form a composite yarn as starting material for producing artificial turf.

In the exemplary embodiment shown, fibrillation by a needle roller is carried out on the whole skein of strips. Basically, however, it is also possible to fibrillate the film by means of a needle roller before it is cut into a plurality of strips. Cutting and subsequently stretching the fibrillated film enable special effects to be produced in the fibrillation structure of the strips. To carry out this version of the method, the fibrillation device 9 is arranged immediately before the cutting device 6.

An exemplary embodiment of a needle roller 10 is shown in FIG. 4. The needle roller 10 usually has a plurality of needle strips 28 which are equipped with a multiplicity of needles 29. In doing so, the arrangement of the needles 29 and the needle strip 28 can be chosen such that different fibrillation patterns are produced. Parallel arrangements of needles and offset arrangements of needles are therefore possible.

Some exemplary embodiments of fibrillation patterns which can be produced on a strip 24 are shown in FIG. 5. The top strip in FIG. 5 has a fibrillation pattern 30 with parallel cuts in the strip 24. Fibrillation patterns of this kind are produced by parallel needles on the needle roller.

In contrast, the fibrillation pattern 30 in the bottom strip 24 exhibits a mesh-like structure which is produced by offset arrangements of the needles on the needle roller. Different needle densities and different strip wrap angles can also be chosen to set up the fibrillation patterns.

The method according to the invention and the device according to the invention are basically suitable for producing a grass yarn from all conventional thermoplastic materials. In particular, however, materials such as PP, LLDPE, HDPE or PA, for example, have proved their worth. At the same time, these polymers can also be extruded in combination to form a film by means of a coextrusion process.

### List of References

1 Extrusion device
2.1, 2.2 Extruder
3 Extrusion head
4 Cooling bath
5 Deflector unit
6 Cutting device
7.1, 7.2 Godet feed unit
8 Heating device
9 Fibrillation device
10 Needle roller
11 Guide bar
12 Crimping device
13.1, 13.2 . . . Texturing means
14.1, 14.2 Godet unit
15 Conveyer nozzle
16 Compression chamber
17 Discharge roller
18 Coiler
19.1, 19.2 . . . Coiler station
20 Deflector roll
21 Spool holder
22 Spool
23 Film
24 Strip
25 Electric motor
26 Control unit
27 Machine controller
28 Needle strip
29 Needle
30 Fibrillation pattern
31 Dancer arm controller
32 Iridescing device
33 Snubber roll

1.-11. (canceled)

12. A method for producing a grass yarn for artificial turf, said method comprising:
producing a film from a polymer material in an extrusion process;
dividing the film into a plurality of strips; and
crimping the strips before being coiled into a plurality of spools,
wherein the film or strips is/are fibrillated by a needle roller before crimping and wherein, after fibrillation, the strips are separated and crimped individually independently of each other.

13. The method as claimed in claim 12, wherein the needle roller for producing a fibrillation pattern is driven at a peripheral speed which is substantially equal to or not equal to a production speed of the film or strips.

14. The method as claimed in claim 12, wherein the fibrillation pattern can be produced in the film or strips by a parallel arrangement of needles or an offset arrangement of needles on the needle roller.

15. The method as claimed in claim 12, wherein the fibrillated strips are crimped individually within a compression chamber, wherein the strip is fed through a conveyor nozzle to the compression chamber.

16. The method as claimed in claim 12, wherein the crimped strips are brought together with others to form a composite yarn before being coiled.

17. The method as claimed in claim 12, wherein the film is produced by coextrusion of two polymer materials based on a polymer of different colors.

18. A device for producing a grass yarn for artificial turf, said device comprising:
an extrusion device for producing a film;
a cutting device for dividing the film into a plurality of strips;
a crimping device; and
a coiler with a plurality of coiler stations for coiling the strips into spools,
wherein a fibrillation unit with at least one needle roller is disposed before the crimping unit, wherein the needle roller is arranged before the cutting device for fibrillating the film or after the cutting device for fibrillating the strips, and wherein the crimping device has a plurality of texturing means for crimping individual strips.

19. The device as claimed in claim 18, wherein the needle roller can be driven by an electric motor which can be controlled by a control unit coupled to a machine controller.

20. The device as claimed in claim 18, wherein the needle roller has a plurality of rows of needle strips with individually protruding needles, wherein the needles are retained in the needle strips parallel to or offset from each other.

21. The device as claimed in one of claim 18, wherein the texturing means are in each case in the form of a compression chamber texturing device, and wherein a separate compression chamber and a conveyor nozzle are associated with each of strips.

22. The device as claimed in claim 19, wherein the extrusion device in each case has one or two extruders for fusing polymer materials.
